(19) United States
(12) Patent Application Publication
(10) Pub. No.: US 2016/0126755 A1
(43) Pub. Date: May 5, 2016

(54) Battery Charging System and Method

(71) Applicant: EH Europe GMBH, Zurich (CH)

(72) Inventors: Mohamed Kechmire, Arras (FR); David Letombe, Arras (FR)

(21) Appl. No.: 14/388,480

(22) PCT Filed: Mar. 26, 2013
(86) PCT No.: PCT/EP2013/056435

§ 371 Date: Sep. 26, 2014

(30) Foreign Application Priority Data
Mar. 30, 2012 (EP) 12305373.8

(51) Int. Cl. H02J 7/00

(52) U.S. Cl. CPC H02J 7/007; H02J 7/0052

(57) ABSTRACT

Provided is a method of identifying a battery provided with a wireless battery control device, during a battery charging procedure. The method includes connecting the battery to a battery charger and the battery charger supplying a first current to the battery. The wireless battery control device measures parameters relating to the first current. The battery charger generates and sends a first wireless interrogation signal, the wireless interrogation signal including information relating to parameters of the first current. The first wireless interrogation signal is configured such that a wireless battery control device receiving the interrogation signal compares the information relating to the parameters of the current being received by the associated battery to the information relating to the parameters of the first current that was supplied by the battery charger, and the wireless battery control device sends back a first wireless response signal should the information relating to the parameters match.

### FIELD OF THE INVENTION

The present invention concerns a system and method for charging batteries. More particularly, but not exclusively, this invention concerns a battery charging system and method including a wireless battery control device.

### BACKGROUND OF THE INVENTION

Large industrial batteries may include a battery control device, the battery control device arranged to monitor and record the charging and discharging of the battery to which the battery control device is connected. The battery control device may send this information to a battery charger during the charging process and the information may be used to determine the optimum charging profile for the charging process.

Industrial users of batteries, for example, where batteries are used to power forklift trucks in warehouses, may have a battery charging room where a plurality of battery chargers are simultaneously used to charge a plurality of batteries. Each battery is connected to a single battery charger and in order for the optimum charging profile to be used by the battery charger, it must be able to communicate with the battery control device associated with the battery to which the charger is connected. If the battery control device is physically connected to the battery charger by a wired arrangement, there is no opportunity for confusion. However, wireless battery control devices are exist which may provide advantages over a wired connection. Such a wireless battery control device could be the commercially available WI-IQ device. The WI-IQ device is available from EnerSys EMEA, EH Europe GmbH, Lowenstrasse 32, 8001 Zurich, Switzerland and additional EnerSys sales entities across the world. In order for the battery charger to apply the correct charging profile to the battery, the battery charger must be able to correctly identify the battery to which the charger has been connected. If a plurality of battery chargers are charging a plurality of batteries, each battery including a wireless battery control device, it may be difficult for each battery charger to make this identification.

The present invention seeks to mitigate the above-mentioned problems.

### SUMMARY OF THE INVENTION

The present invention provides a method of identifying a battery provided with a wireless battery control device during a battery charging procedure comprising the following steps:

connecting the battery to a battery charger;

the battery charger supplying a first current to the battery;

the wireless battery control device measuring parameters relating to the first current;

the battery charger generating and sending a first wireless interrogation signal, the wireless interrogation signal including information relating to parameters of the first current;

the first wireless interrogation signal configured such that a wireless battery control device receiving the interrogation signal compares the information relating to the parameters of the current being received by the associated battery to the information relating to the parameters of the first current that was supplied by the battery charger, and the wireless battery control device sending back a first wireless response signal should the information relating to the parameters match.

The information relating to the parameters of the first current preferably include at least one of the parameters measured by the wireless battery control device.

The wireless response signal sent in response to the interrogation signal may include a unique identifier. If the information relating to the parameters detected at the wireless battery control device matches the information relating to the parameters of the first current that was supplied by the battery charger it implies that the current being received by the associated battery may have been sent from the battery charger. If the battery charger receives a wireless response signal from only one wireless battery control device, this indicates that the wireless battery control device is associated with the battery connected to the battery charger.

The method may include the step of forming a communications link with any wireless battery control device that emits a first wireless response signal. Throughout this application, where reference is made to the information relating to the parameters of the wireless response signal matching the information relating to the parameters of the current generated by the battery charger, the skilled person will appreciate that a margin of error is provided and exact matching is not necessary. The tolerance is to compensate for possible losses in the cables connecting the battery to the charger, and potential inaccuracies in measurements taken both at the battery charger and by the wireless battery control device. The skilled person will appreciate that the required tolerance therefore depends on each particular system being used, and the tolerances may be set during a calibration process. The specific description below includes example values of the tolerance levels into which matching parameters may fall.

In order to confirm the correct wireless battery control device has been identified, or to continue the identification process if the battery charger receives two or more signals from wireless battery control devices, the method may include the step of: the battery charger supplying a second current, the second current with parameters different to the parameters of the first current; and the battery charger sending out a second wireless interrogation signal, the wireless interrogation signal including information relating to parameters of the second current; the second wireless interrogation signal configured such that a wireless battery control device receiving the interrogation signal compares the information relating to the parameters of the current being received by the associated battery to the information relating to the parameters of the second current that was supplied by the battery charger, and the wireless battery control device sending back a second wireless response signal should the information relating to the parameters match.

The method may include the step of the battery charger forming a communications link with any wireless battery control device that emits a first wireless response signal. The method may include the step of the second interrogation signal being configured to cause a second wireless response signal to be sent only by wireless battery control devices linked with the control unit. The method may include the step of breaking a link with any wireless battery control device that does not emit a second wireless response signal.

The second signal may be a point-to-point request-answer communication, being sent only to the wireless battery control device/devices that responded to the first signal.

Repeating the interrogation cycle as described will eliminate at least some of the wireless response signals received by the battery charger that are sent from wireless battery control devices that are not associated with the battery connected to the battery charger. The interrogation cycle may be repeated until only a single wireless response signal is received by the battery charger.

Once the battery connected to the charger has been correctly identified by the method as described above, the battery charger may form a control link with the wireless battery control device associated with the battery. The wireless battery control device may provide battery charging and/or discharging information to the battery charger to allow the optimum charging profile to be applied. The wireless battery control device may be arranged to monitor and/or record information relating to:

current output of the battery

current received during a battery charge

voltage output of the battery

voltage at the battery during a battery charge

battery temperature.

battery electrolyte levels

number of charge/discharge cycles

state of charge

Such information may be used by the battery charger to determine the optimum charging profile for the battery. In such an arrangement the battery charger may be the master unit and the wireless battery control device the slave unit.

Alternatively, the optimum charging profile may be determined by the wireless battery control device and sent to the battery charger once the wireless battery control device has been correctly identified and linked with the battery charger. In such an arrangement the wireless battery control device may be the master unit and the battery charger the slave unit.

A further aspect of the invention may provide a battery charger configured for use in the method as described above. The battery charger may comprise a control unit configured to emit and receive wireless signals, and control the charging profile of the battery charging process when a battery is connected to a battery charger. Alternatively, the battery control unit may be configured to be controlled by a wireless battery control device when an associated battery is connected to the battery charger.

A further aspect of the invention provides a wireless battery control device, the wireless battery control device configured for use in the method as described above.

A further aspect of the invention provides a battery charging system comprising: a battery charger comprising a control unit; and a battery provided with a wireless battery control device; wherein the battery charger and battery are configured for use as described in the method above.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows a schematic representation of a battery charger and battery according to a first embodiment of the invention; and

FIG. 2 shows a flow chart showing a method of battery identification according to a first embodiment of the invention.

### DETAILED DESCRIPTION

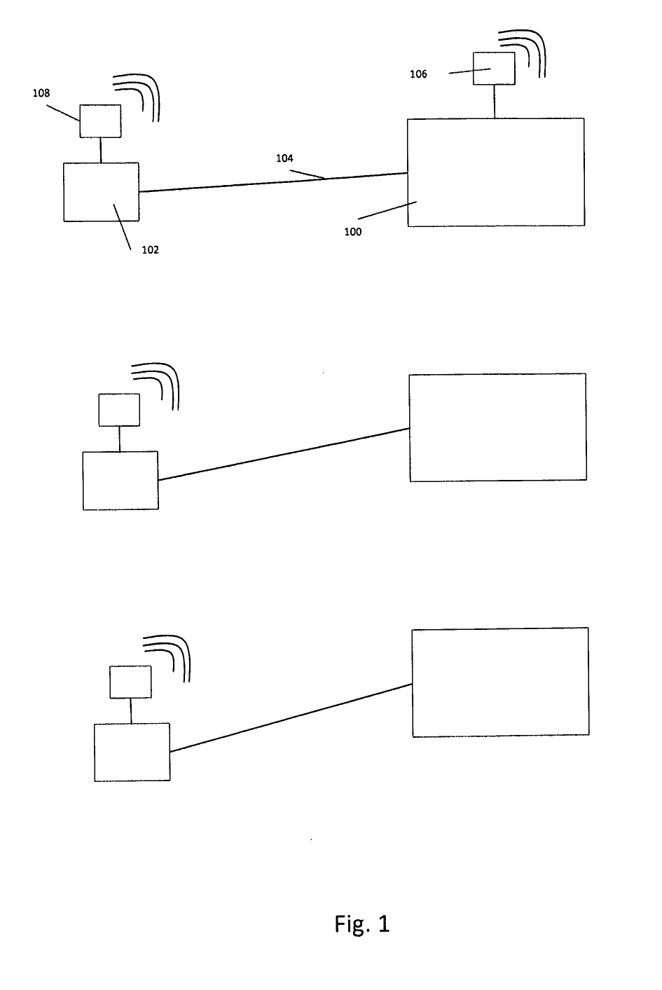

FIG. 1 shows a schematic diagram of a battery charger 100 and battery 102. The battery charger 100 is connected to the battery 102 by charging leads 104. The battery charger includes a control unit 106 and the battery 102 includes a wireless battery control device (WBCD) 108. The wireless battery control device may be an EnerSys WI-IQ device as described above. The method described below allows the control unit 106 of the battery charger 100 to identify and form a control link with the wireless battery control device 108 that is associated with the battery 102. FIG. 1 also shows a typical charging room setup with a number of other battery chargers and batteries that the battery charger 100 may mistakenly link with if not taking advantage of the present invention. The control unit 106 and wireless battery control device 108 are arranged to communicate wirelessly using the simple media access control (SMAC) of the Zigbee protocol operating at 2.4 GHz. However, the skilled person will realise that any suitable wireless communication system and method may be used with routine implementation.

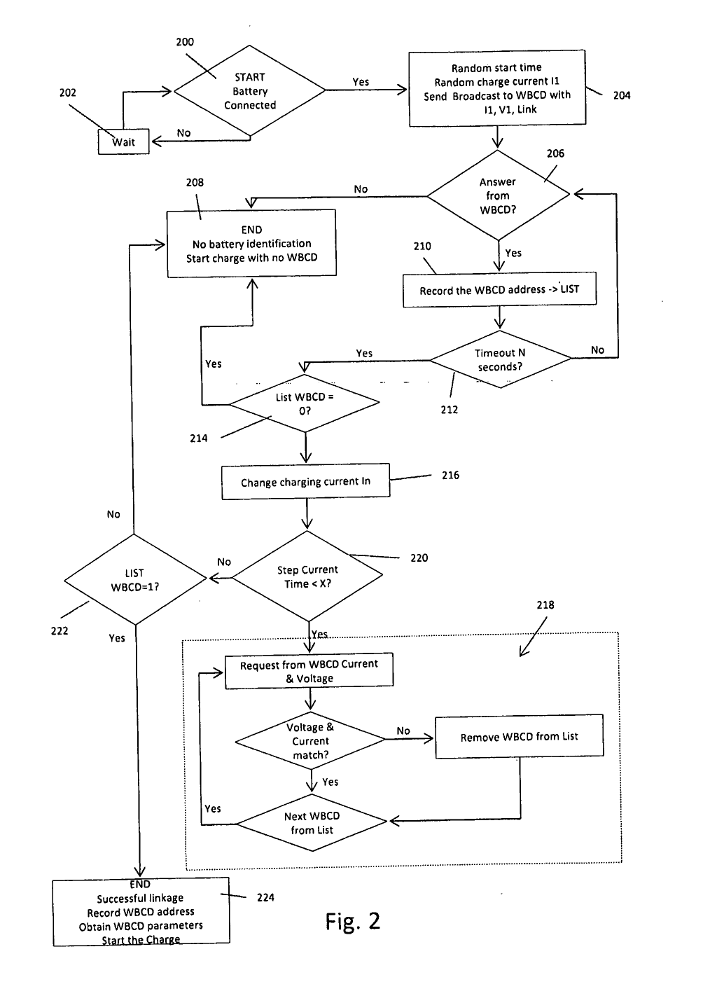

FIG. 2 shows a flow diagram detailing a method of battery identification according to a first embodiment of the invention. The control unit 106 of the battery charger 100 first checks to see if a battery is connected to the battery charger 100, as shown in step 200. If no battery is connected, the control unit waits 202 before repeating step 200. If the control unit 106 detects that a battery is connected to the battery charger 100 it moves onto step 204. At step 204 the battery charger 100 generates and supplies a random current output to the battery 102 after a random delay. The random current may be from 5 A to 140 A depending on the rating of the charger 100. The random delay may range from 20 seconds, to 90 seconds, to any number of minutes. The purpose of the random delay is to prevent all of the chargers in a charging room starting at the same time after a power failure. If this were to happen there may be an unacceptably large surge in the power supply demand of the battery charging room or factory. The charger 100 sends out the random current after the random delay. Along with the random current the control unit 106 sends out a wireless interrogation signal to determine whether there are any wireless battery control units in range. The wireless interrogation signal includes the value of the random current generated, the voltage generated and a link request. The control unit 106 then waits to see if any answer is received in response of the interrogation signal, as shown at 206. If no response is received the control unit 106 instructs the battery charger 100 to begin the charging process without linking to a wireless battery control device, as shown in 208. If a wireless battery control device receives the interrogation signal, and that wireless battery control device is already linked to a battery charger, the wireless battery control device is arranged not to send a response to the interrogation signal. If the wireless battery control device is not already linked to a battery charger, and the current and voltage parameter information included in the interrogation signal match those being monitored by the wireless battery control device, a response signal is sent back to the charger, including a unique identifier for that wireless battery control device. The control unit 106 receives the response signal and records the unique identifier of the wireless battery control device as shown in 210. The wireless battery control device determines that the current and voltage parameter information matches that included in the interrogation signal if the current is within ±5 A and the voltage within ±4 V. This allows for inaccuracies in the readings taken by the wireless battery control device and/or cable losses between the battery and the battery charger.

After waiting a predetermined time 212, the control unit 106 checks to see whether the details of any wireless battery control devices have been recorded, as shown at 214. If zero wireless battery control devices have been recorded, the charging process begins without reference to any link to a wireless battery control device, as shown at 208. If at least one wireless battery control device has been recorded the battery control unit 106 moves to step 216. The control unit 106 then changes the current being produced by the battery charger 100. The battery charger 100 sends a second wireless interrogation signal to each of the wireless battery control devices that it has previously recorded. The interrogation signal asks each of the wireless battery control devices in the list if the current and voltage they are monitoring matches that being supplied by the battery charger 100. If the current and voltage do match, to within the tolerances mentioned above, then the wireless battery control device sends a second wireless response signal to the battery charger 100 and the battery remains on the list recorded by the control unit 106. If the current and voltage do not match, the wireless battery control device does not send a second wireless response signal and that battery is removed from the list. This is shown in the cycle 218. Once each of the initially recorded wireless battery control devices have been checked and removed as appropriate, the control device 106 returns to step 214. The cycle is repeated for a set amount of time 220, which may range from 30 seconds to two minutes. After the set amount of time has expired the control unit checks whether the number of recorded wireless battery control units is equal to one, as shown in step 222. If so, the control unit 106 forms a control link with the wireless battery control device and receives information relating to the battery 102 to which the battery charger 100 is connected, as shown in step 224. This information is used to optimise the charging process of the battery 102. If the number of wireless battery control devices recorded is not equal to one, then the control unit 106 goes to step 208 and the charging process is started without linking the control unit 106 to a wireless battery control device.

By cycling through various outputs, and comparing those outputs to what each wireless battery control device is monitoring as an input on their associated battery, the method is able to eliminate the wireless battery control devices that are not connected to the right battery. While it is possible that two wireless battery control devices would be registering the same current and/or voltage at one time, once the battery charger output has changed, the wireless battery control device that is connected to the battery charger will register different current/voltage values.

Whilst the present invention has been described and illustrated with reference to particular embodiments, it will be appreciated by those of ordinary skill in the art that the invention lends itself to many different variations not specifically illustrated herein.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A method of identifying a battery provided with a wireless battery control device during a battery charging procedure comprising the following steps:
connecting the battery to a battery charger;
the battery charger supplying a first current to the battery;
the wireless battery control device measuring parameters relating to the first current;
the battery charger generating and sending a first wireless interrogation signal, the wireless interrogation signal including information relating to parameters of the first current;
the first wireless interrogation signal configured such that a wireless battery control device receiving the interrogation signal compares the information relating to the parameters of the current being received by the associated battery to the information relating to the parameters of the first current that was supplied by the battery charger, and the wireless battery control device sending back a first wireless response signal should the information relating to the parameters match.

2. A method as claimed in claim 1, in which the wireless response signal sent in response to the interrogation signal includes a unique identifier.

3. A method as claimed in claim 1, including the step of the battery charger forming a link with any wireless battery control device that emits a first wireless response signal.

4. A method as claimed claim 1, the method including the step of:
the battery charger supplying a second current, the second current with parameters different to the parameters of the first current; and
the battery charger sending out a second wireless interrogation signal, the wireless interrogation signal including information relating to parameters of the second current;
the second wireless interrogation signal configured such that a wireless battery control device receiving the interrogation signal compares the information relating to the parameters of the current being received by the associated battery to the information relating to the parameters of the second current that was supplied by the battery charger, and the wireless battery control device sending back a second wireless response signal should the information relating to the parameters match.

5. A method as claimed in claim 4, including the step of the battery charger forming a link with any wireless battery control device that emits a first wireless response signal, wherein the second interrogation signal is configured to cause a second wireless response signal to be sent only by wireless battery control devices linked with the control unit.

6. A method as claimed in claim 5, including the step of breaking a link with any wireless battery control device that does not emit a second wireless response signal in response to the second interrogation signal.

7. A method as claimed claim 1, wherein the battery charger is arranged to set up a point-to-point request-answer communication with any wireless battery control device which sends back a first wireless response signal.

8. A method according claim 1, including the step of repeating the interrogation signal and wireless response signal cycle until only a single wireless response signal is received by the battery charger.

9. A method as claimed in claim 8, wherein the battery charger forms a control link with the single battery control device.

10. A method as claimed in claim 9, including the additional step of the single battery control device sending a battery charging profile to the battery charger.

11. A battery charger configured for use in the method of claim 1.

12. A battery charger as claimed in claim 11, the battery charger comprising a control unit configured to emit and receive wireless signals, and control the charging profile of the battery charging process when a battery is connected to the battery charger.

13. A battery charger as claimed in claim 11, the battery charger comprising a control unit configured to emit and receive wireless signals, and the control unit being configured to be controlled by a wireless battery control device when an associated battery is connected to the battery charger.

14. A wireless battery control device, the wireless battery control device configured for use in the method as claimed in claim 1.

15. A battery charging system comprising:
a battery charger comprising a control unit; and
a battery provided with a wireless battery control device;
wherein the battery charger and battery are configured for use as described in claim 1.
